(19) United States
(12) Patent Application Publication
(10) Pub. No.: US 2008/0251425 A1
(43) Pub. Date: Oct. 16, 2008

(54) Process and Machine For Recovering Capsules From Inside Slaughtered Animals

(75) Inventors: Xavier Torras Soler, Vic (ES); Joan Francesc Vilaseca Vintro, Barcelona (ES); Gerardo Caja Lopez, Sant Cugat del Valles (ES)

Correspondence Address: SUGHRUE MION, PLLC, 2100 PENNSYLVANIA AVENUE, N.W., SUITE 800, WASHINGTON, DC, 20037, US

(73) Assignee: Rumitag, S.L., Esplugues de Llobregat (ES)

(21) Appl. No.: 11/667,545

(22) PCT Filed: Oct. 31, 2005
(86) PCT No.: PCT/EP05/11628

§ 371 Date: Jan. 10, 2008

(30) Foreign Application Priority Data
Nov. 11, 2004 (ES) P 200402712

(51) Int. Cl. B07C 5/00; A01K 11/00

(52) U.S. Cl. 209/2; 452/106

(57) ABSTRACT

Process and machine for recovering capsules from inside slaughtered animals, characterized in that said process comprises the following steps of emptying the cavity of the slaughtered animal where the capsule is located, such as the stomach, removing the capsule mixed up with the remains lodged inside said cavity; chopping up said remains; gravity-unloading of said chopped up remains via a substantially vertical pipe with means for detecting capsules that emit a signal upon detection of a passing capsule; activating separation means in response to the signal emitted by the detection means, which divert the capsule from the downward falling path caused by gravity; and storing the capsule diverted from its path into storage means.

### TECHNICAL FIELD OF THE INVENTION

The invention relates to a process and a machine that enable capsules to be recovered from inside slaughtered animals, especially in those cases where the capsule is lodged in the stomach of the slaughtered animal.

### BACKGROUND OF THE INVENTION

Various methods are known for identifying animals which consist, for example, in placing tags with inscriptions on the ears of the animals. These methods are usually very cost-effective and identification of the animal is purely visual, by reading the inscriptions. However, this type of identification involves some problems since, when placing said tags on an external part of the animal, they can easily come off, thus preventing the correct identification of the animal, and even causing damage to its ear.

In order to solve said problems, as shown in documents DE10137470 and DE10137471, many livestock farmers opt to use receptacles that encapsulate electronic means of identification, such as transponders, which can generate identifying signals. These receptacles, called capsules, are administered orally to the animals and remain inside them, particularly in the first stomach of ruminants. Once the capsule is lodged in the first stomach of the animal, said capsule cannot be removed until the animal is slaughtered. The quick and effective recovery of these capsules is a prime objective of the present invention.

Up until now, the process for recovering these capsules has been manual, in other words, once the animal is slaughtered, the stomach must be separated, opened and the capsule found from where it is lodged inside, mixed among other remains, with the high costs in terms of time and labour that this involves.

In addition, in the process of recovering the capsules, the use of water pressure to separate the capsule from the contents of the animal's stomach must be avoided, since the use of water would generate dirty residual water which would need subsequent treatment before disposal, again resulting in an additional cost increase.

Similarly, when the recovery process is done manually, the indiscriminate and non-controlled reutilization of recovered capsules cannot be guaranteed, which is why improving the system for controlling the capsules recovered is also an object of the invention.

The present invention solves the aforementioned problems, as it incorporates an automatic system for detecting and separating capsules which require neither water nor human intervention to recover them, the collection thereof also being controlled.

### EXPLANATION OF THE INVENTION

The process of the invention to recover capsules from inside slaughtered animals is characterized in that it comprises the steps of emptying the cavity of the slaughtered animal where the capsule is located, such as the stomach, removing the capsule mixed up with the remains lodged inside said cavity; chopping up said remains; gravity-unloading of said chopped up remains via a substantially vertical pipe with means for detecting capsules that emit a signal upon detection of a passing capsule; activating separation means in response to the signal emitted by the detection means, which divert the capsule from the downward-falling path caused by gravity; and storing the capsule diverted from its path into storage means.

In accordance with another aspect of the invention, the machine for carrying out the process of the invention comprises means for collecting and conducting the slaughtered animal remains among which the capsule is mixed; means for chopping up and transporting said remains, connected via an inlet point to the collection and conduction means and with an outlet point for the chopped up remains; a substantially vertical tubular pipe, connected to the outlet point of the chopping up and transporting means, with at least one element for detecting a passing capsule which emits a control signal upon detection of a passing capsule; means for separating the capsule from said chopped up remains, automatically activated by the control signal emitted by the detector element; and means for storing the capsule separated from said chopped up remains.

In accordance with another characteristic of the invention, the collection and conduction means comprise a hopper with an essentially vertical pipe in its lower end for gravity-unloading.

According to another characteristic of the machine of the invention, the chopping up and transporting means are made up of an essentially horizontal tubular pipe wherein there is an endless screw driven by an electric motor, one of the ends of said pipe having an inlet point, suitable for receiving the remains from the slaughtered animal cavity from the unloading pipe of the collection and conduction means, while the other end has an outlet point, suitable for the gravity-unloading of the chopped up remains.

In accordance with another characteristic of the machine of the invention, the means for separating the capsule from said chopped up remains comprise a device for switching between at least two positions: the first, open, for the free unloading of said remains via the vertical pipe; and a second, wherein the capsule hits the switching device, diverting the capsule from its path, so that the switching device will instantaneously switch from first to second position in response to the control signal from the means for detecting the capsule, later returning to its original position.

According to another characteristic of the machine of the invention, the means for storing the separated capsules comprise a closed receptacle with at least one opening for automatic introduction of the capsules separated via the separation means.

In a preferred embodiment of the invention, the opening is configured in the form of a funnel, its section narrowing out in the direction in which the capsules are introduced in the closed receptacle, the closed receptacle preferably also having an inner access door with a controlled opening device, such as an electronic or mechanical lock.

### BRIEF DESCRIPTION OF THE DRAWINGS

The attached drawings represent, as a non-restrictive example, an example of embodiment of the process and the machine of the invention. In said drawings:

FIG. 1 is a diagrammatic view of the machine of the invention;

FIGS. 2a and 2b are diagrammatic views showing the functioning of the separation means of the machine of the invention; and

FIG. 3 is a diagrammatic view of a form of embodiment of the means for storing the separated capsules.

### DETAILED DESCRIPTION OF THE DRAWINGS

The process to recover capsules from inside slaughtered animals, being the prime objective of the invention, permits said recovery without the need to use water for this purpose. The process comprises the steps of emptying the cavity of the slaughtered animal where the capsule is located, removing said capsule together with the remains lodged in the cavity; chopping up said remains; gravity-unloading of the remains, now chopped up, via a substantially vertical pipe with means for detecting capsules that emit a signal upon detection of a passing capsule; and activating separation means in response to the signal emitted by the detection means, which divert the capsule from the downward-falling path caused by gravity, which can automatically store the capsule diverted from its path into storage means.

The machine for the process of the invention which is described as an example of embodiment, comprises means for collecting and conducting remains 2 of the slaughtered animal, means for chopping up and transporting said remains 2, a substantially vertical tubular pipe 3, separation means 5 and storage means 6.

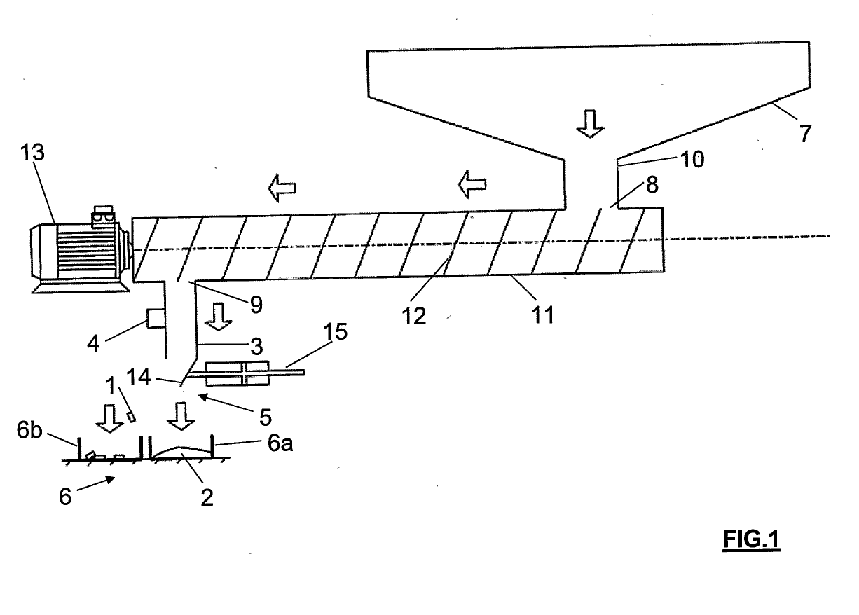

As can be seen in FIG. 1, the means for collecting and conducting the remains 2 mixed up with a capsule 1 comprise a hopper 7 which has an essentially inverted trunk-conical outline, along the inner walls of which the remains 2 of the slaughtered animals 2 and the capsule 1 will slide due to gravity. The hopper 7 is preferably made of stainless steel, due the fact that the remains 2 that slide along its inner surface contain corrosive components, and will also contain high anti-sliding properties to prevent the remains 2 from sticking to said inner surface.

As can also be seen in FIG. 1, the machine of the invention comprises some chopping up and transporting means which themselves comprise an essentially horizontal tubular pipe 11, an endless screw 12, an electric motor 13, an inlet point 8 and an outlet point 9, all of this adapted so that the hopper 7 is connected to said chopping up and transporting means via an unloading pipe 10, positioned between the outlet of the hopper 7 and the inlet point 8 of the chopping up and transporting means. Once the capsule 1 and the remains 2 are in the chopping up and transporting means, the remains 2 are chopped up by the endless screw 12, driven by the electric motor 13, while both the remains 2 and the capsule 1 are transported as indicated by the direction of the arrows in FIG. 1 via a rotation-motion movement which impresses the rotation of the endless screw 12 upon the unit made up by the remains 2 and the capsule 1.

In the end of the essentially horizontal tubular pipe 11 is the outlet point 9 of the chopping up and transporting means which are connected to a substantially vertical tubular pipe 3 with an element for detecting 4 passing capsules 1. Both the chopped up remains 2 and the capsule 1 fall, due to gravity, through said substantially vertical tubular pipe 3, the detector element 4 emitting an activation signal upon detecting a passing capsule 1.

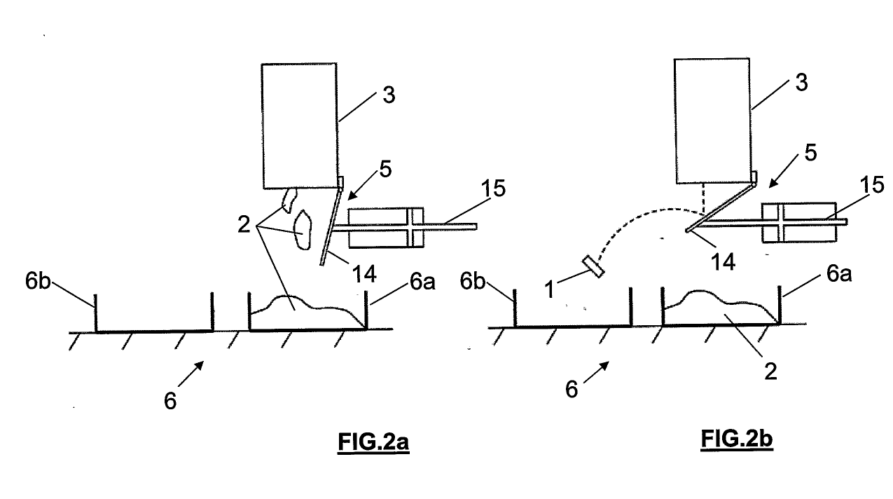

As can be seen in FIGS. 2a and 2b, the machine of the invention comprises means for separating 5 the capsule 1 from the chopped up remains 2. Said separation means 5 comprise a switching device 14 and an actuator 15. Said actuator will preferably be an electro-pneumatic piston, the valve of which (not shown) will be governed by the control signal emitted by the detector element 4. The switching device 14 switches between two positions: the first, an open position (FIG. 2a), which enables the vertical unloading of the chopped up remains 2, corresponding to the absence of any signal from the detector element 4; and a second position (FIG. 2b), wherein the detector element 4 detects a passing capsule 1 via the vertical pipe 3 and emits a control signal to the separation means 5, automatically activating them, so that the actuator 15 positions the switching device 14 as can be seen in FIG. 2b, in such a way that the capsule 1 hits said switching device 14. The impact diverts the capsule 1 from its path. Once the capsule 1 has hit the switching device 14, the latter returns to the first position.

It can be seen in FIGS. 1, 2a and 2b that the machine of the invention has some solid storage means 6 in two recipients, referenced as 6a and 6b. The recipient 6a is used to store the chopped up remains 2, positioned just below the vertical pipe 3 so that the free fall, due to gravity, of said chopped up remains 2 will enable the storage thereof. The recipient 6b is used to store the capsules 1 and is positioned on the path of the capsule 1 after hitting the switching device 14.

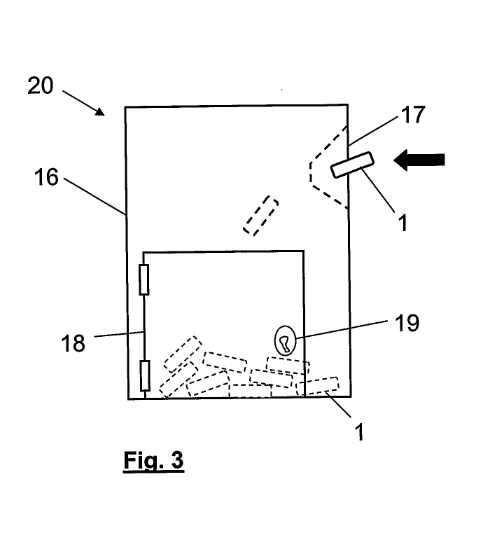

FIG. 3 represents a specific form of embodiment of some storage means 20, which incorporate characteristics for controlling the recovered capsules. More specifically, the storage means 20 comprise a closed receptacle 16 with an opening 17 configured in the form of a funnel for automatically introducing the capsules 1 separated by the separation means 5 (not represented). This particular configuration avoids a person from being able to introduce their hand, or arm, inside the receptacle 16 to remove the capsules stored inside.

The closed receptacle 16 in FIG. 3 also has a door 18, with internal access to the receptacle, which incorporates a controlled opening device 19, such as an electronic lock, which requires an access code, or a mechanical lock, which requires the correct key to open the door 18.

1. A process for recovering capsules (1) from inside slaughtered animals, comprising the following steps:
emptying the cavity of the slaughtered animal where the capsule (1) is located, such as the stomach, removing the capsule (1) mixed up with the remains (2) lodged inside said cavity;
chopping up said remains (2);
gravity-unloading of said remains (2), now chopped up, via a substantially 10 vertical pipe (3) with means for detecting (1) capsules (1) which emit a signal upon detection of a passing capsule (1);
activating separation means (5) in response to the signal emitted by the detection means (4), which divert the capsule (1) from the downward-falling path caused by gravity; and
storing the capsule (1) diverted from its path into storage means (6).

2. A machine for the process in claim 1, comprising:
means for collecting and conducting the remains (2) of the slaughtered animal, among which a capsule is mixed (1);
means for chopping up and transporting said remains (2), connected via an inlet point (8) to the collection and conduction means and with an outlet point (9) for the chopped up remains (2);
a substantially vertical tubular pipe (3), connected to the outlet point (9) of the chopping up and transporting means, with at least one element for detecting (4) a passing capsule (1) which emits a control signal upon detection of a passing capsule (1);
means for separating (5) the capsule (1) from said chopped up remains (2) automatically activated by the control signal emitted by the detector element; and
means for storing (6, 15) the capsule (1) separated from said chopped up remains (2).

3. The machine according to claim 2, wherein the collection and conduction means comprise a hopper (7) with an essentially vertical gravity-unloading pipe (10) in its lower end.

4. The machine according to claim 2, wherein the chopping up and transporting means are comprised of an essentially horizontal tubular pipe (11) wherein there is an endless screw (12) driven by an electric motor (13), one of the ends of said pipe having an inlet point (8), suitable for receiving the remains (2) of the slaughtered animal cavity from the unloading pipe (10) of the collection and conduction means, while the other end has an outlet point (9), suitable for gravity-unloading of the chopped up remains (2).

5. The machine according the claim 2, wherein the separation means (5) of the capsule (1) from said chopped up remains (2) comprise a switching device (14) which switches between at least two positions: the first, open, for the free unloading of said remains (2) via the vertical pipe (3); and the second, wherein the capsule (1) hits the switching device (14), diverting the capsule from its path, so that the switching device (14) will instantaneously switch from first to second position in response to the control signal from the means for detecting (4) the capsule (1), later returning to its original position.

6. The machine according to claim 2, wherein the storage means (20) of the separated capsules comprise a closed receptacle (16) with at least one opening (17) for automatic introduction of the capsules (1) separated via the separation means (5).

7. The machine according to claim 6, wherein the opening (17) is configured in the form of a funnel, its section narrowing out in the direction in which the capsules (1) are introduced in the closed receptacle (16).

8. The machine according to claim 6, wherein the closed receptacle (16) has an internal access door (18) with a controlled opening device, such as an electronic or mechanical lock.
